(19) United States
(12) Patent Application Publication
(10) Pub. No.: US 2005/0123131 A1
(43) Pub. Date: Jun. 9, 2005

(54) Cryptographic system comprising an encryption and decryption system and a key escrow system, and the associated equipment and devices

(75) Inventors: David Naccache, Paris (FR); Francoise Levy-Dit-Vehel, Paris (FR); Jacque Stern, Paris (FR)

Correspondence Address: BURNS DOANE SWECKER & MATHIS L L P, POST OFFICE BOX 1404, ALEXANDRIA, VA, 22313-1404, US

(73) Assignee: Gemplus, Gemenos (FR)

(21) Appl. No.: 10/817,453

(22) Filed: Apr. 5, 2004

Related U.S. Application Data
(63) Continuation of application No. 09/377,666, filed on Aug. 19, 1999, now abandoned.

(30) Foreign Application Priority Data
Feb. 17, 1998 (US) WO98/37662
Feb. 19, 1997 (FR) 97/02244

(51) Int. Cl. H04K 1/00

(52) U.S. Cl. 380/30

(57) ABSTRACT

The present invention concerns a cryptographic system, combining the so-called discrete logarithm and factorization principles, comprising an encryption and decryption system and a key escrow system, and the associated equipment and devices. It is particularly intended to be used in electronic systems of the type comprising chip cards, PCMCIA cards, badges, contactless cards or any other portable equipment.

The present invention concerns a cryptographic system, comprising an encryption and decryption system and a key escrow system, and the associated equipment and devices.

It is particularly intended to be used in electronic systems of the type comprising chip cards, PCMCIA cards, badges, contactless cards or any other portable equipment.

The majority of public key cryptography systems (also referred to as asymmetric cryptography)
existing today use the RSA encryption algorithm, published in 1978 by R. Rivest, A. Shamir and L. Adleman, and then patented under the title <<Cryptographic Communications System and Method>> and the reference U.S. Pat. No. 4,405,829.

The RSA system apart, there are very few practical public key encryption methods and systems. There is, however, another system, less well-known and relatively little used: this is the El-Gamal system, known by the title <<A public-key cryptosystem and a signature scheme based on discrete logarithms>> and published in the journal IEEE Transactions on Information Theory, vol. IT-31, no. 4, 1985, pp. 469-472.

An RSA or El-Gamal cryptogram is in fact a large number represented in a computer by strings of binary or hexadecimal digits. The cryptogram is calculated with the help of a software calculation resource (a program) and/or a hardware calculation resource (an electronic circuit) using a series of calculation rules (the encryption algorithm) having to be applied at the time of processing a set of parameters accessible to all in order to hide the content of the processed data. In an analogous manner, the cryptogram is decrypted with the help of a software or hardware calculation resource using a series of calculation rules (the decryption algorithm) applied (by the receiver of the cryptogram) to a set of secret and public parameters and the cryptogram.

The encryption system or method makes use of a public key in order to produce the cryptogram. The decryption method uses a private key which corresponds to the secret key without, however, being identical to it. A user of an item of portable electronic equipment, for example a chip card, possesses a pair of keys (referred to as a public key and a secret key). It is assumed that the public keys are known to all users whereas the secret keys are never disclosed. Any person has the ability to encrypt a message for a user by using the public key of the latter, but cryptograms cannot be decrypted other than by using the secret key of the user.

By way of illustration, the operation of the well-known RSA algorithm will be described below.

The parameters of the RSA algorithm are:
1. Two secret prime numbers p and q equal in size to at least 256 bits. These prime numbers are generated in a particular manner, the detail of which is not essential to the understanding of the present invention but can however be found in the work <<Applied Cryptography, Algorithms, Protocols and Source Codes>>, by Bruce Schneier (Translation by Marc Vauclair), Thomson Publishing.
2. A public modulus n=pq.
3. A pair of exponents denoted. {e, d}, e being a public exponent and d a secret exponent such that:
   ed=1 mod(p−1)(q−1)

The exponent e, referred to as the <<encryption exponent>>, is accessible to all whereas the <<decryption exponent>> d must remain secret.

In order to encrypt the message m, the sender calculates the cryptogram c=m^{e} mod n and the receiver or checking device decrypts c by calculating m=c^{d} mod n.

As regards the operation of the El-Gamal algorithm, this is a little more complex and is of no particular interest for understanding the present invention.

The present invention concerns a cryptographic system comprising an alternative public key encryption/decryption system which presents an alternative to the RSA method and to the El-Gamal method and a key escrow system.

According to the invention, provision is made that the cryptographic system combining the so-called discrete logarithm and factorization principles, comprises, among other things, public keys and a secret key, and is characterised in that the said public keys comprise, at least:
a. an RSA modulus n, greater in size than 640 bits, having the following property:
   n=(Ap_{A}+1)×(Bp_{B}+1)
   in which:
   p_{A} and p_{B} are prime numbers greater in size than 320 bits,
   (Ap_{A}+1) is an RSA prime denoted p,
   (Bp_{B}+1) is an RSA prime denoted q,
   A is the product of k/2 (k being an even integer number between 10 and 120) prime numbers (denoted p[i], i=1 to k/2) of relatively small size (between 2 and 16 bits) and
   B is the product of k/2 prime numbers (also denoted p[i], i=k/2+1 to k)
   the p[i]s being of relatively small size (between 2 and 16 bits), and also able to be mutually prime;
b. an exponentiation base g, of order Φ(n)/4 (where φ(n) denotes the Euler indicator function), g therefore having not to be a p[i]-th power modulo n of any number.

More precisely, the invention relates to a cryptographic system comprising at least an encryption/decryption system, characterised in that the encryption of a message m, m<AB, consists of the operation:
c=g^{m} mod n
where c denotes the cryptogram (encrypted message).

Preferentially, the cryptographic system according to the invention is characterised in that the integrity of m can be provided by the encryption of m|h(m) (h denoting a hashing function and | denoting concatenation), or by the encryption of DES(key, m), <<key>> being a key accessible to all.

An object of the present invention is also the description of an escrow system. According to the invention, the said secret key of the decrypter or of the escrow centre is the number φ(n) and the operation of decryption or of recovering the identity of a user consists of the following steps:
a. calculating, for i from 1 to k: y[i]=c^{φ(n)/p[i]} mod n;
b. for i from 1 to k
   for j from 1 to p[i]
   comparing y[i] with the values g^{jφ(n)/p[i]} mod n independent of m; if g^{jφ(n)/p[i]} mod n=y[i] then assign μ[i]=j
c. reconstructing the message m from the Chinese remainder theorem (CRT) and the values μ[i].

According to a variant embodiment, the said decrypter speeds up the calculation of the quantities y[i] by calculating:
a) z=c^{r} mod n where r=p_{A}p_{B}
b) for i from 1 to k: y[i]=z^{AB/p[i]} mod n,
   so as to take advantage of the difference in size between AB/p[i] and φ(n)/p[i] for speeding up the calculations.

According to another variant embodiment of the invention, the decrypter pre-calculates and saves, once and for all, the table of values g^{jφ(n)/p[i]} mod n for 1≦i≦k and 1≦j≦p[i] or,

more specifically, a truncation or a hashing of these values (denoted h) having the following property:
h(g^{jφ(n)/p[i]} mod n)≠h(g^{j′φ(n)/p[i]} mod n) if j≠j′.

In this way, this avoids on the one hand the recalculation for each i of the quantities g^{jφ(n)/p[i]} mod n, and on the other hand the storage of values which are too large.

According to another preferential embodiment of the invention, the decrypter speeds up its calculations by separately decrypting the message modulo p and then modulo q, and constructing the modulo results with the help of the Chinese remainder theorem in order to find m again.

The escrow system is implemented by the following operational steps:
a. the escrow authority codes the identity of the user ID=Σ2ⁱ⁻¹ID[i] where ID[i] are the bits of the identity of the said user of the system (the sum being taken for i from 1 to k) by calculating e(ID)=Πp[i]^{ID[i]} (the product being taken for i from 1 to k);
b. it issues, to the user, an El-Gamal key (that is to say an exponentiation base) c=g^{e(ID)u} mod n,
   in which u is a large random prime or a number prime with φ(n);
c. it thus makes it possible for the user to derive, from c, his El-Gamal public key by choosing a random number x and raising c to the power x modulo n.
d. with the aim of finding the trace of the user, the authority extracts, from the El-Gamal cryptogram of the encrypter, the said cryptogram always comprising two parts, the part:
   v=c^{r} mod n
   where r is the encryption random number chosen by the encrypter.
e. Knowing φ(n), the said authority finds the bits ID[i] by means of the following algorithm:
   1. calculate, for i from 1 to k: y[i]=v^{φ(n)/p[i]} mod n
   2. if y[i]=1, then μ[i]=1, otherwise μ[i]=0
   3. calculate:
      ID′=Σ2ⁱ⁻¹μ[i]
   4. find ID=CCE(ID′)
      in which CCE denotes an (optional) error correction mechanism (of the type of those described in the work <<Correction Codes, Theory and Practice>> by A. Poli and L. Huguet, published by Masson) intended to correct the perturbations introduced in the case of an illicit use of a composite r.

Another escrow system proposed is based on the so-called Diffie-Hellman key exchange mechanism where a number c, obtained by raising g to a random power a modulo n by one of the parties, is intercepted by the said escrow authority:
c=g^{a} mod n
the said escrow authority finds a again in the following manner:
a. knowing the factorization of n, the said authority finds, with the help of the decryption algorithm, the value
   α=a mod AB
   that is a=α+βAB;
b. the said authority calculates: λ=c/g^{α} mod n=g^{βAB} mod n
c. using a cryptanalysis algorithm (a discrete logarithm calculation algorithm, possibly executed twice (modulo p and modulo q) in order to speed up the performance thereof), the authority calculates the discrete logarithm β
   λ=(g^{AB})^{β} mod n
d. the said authority finds
   a=α+βAB
   and decrypts the communications based on the use of a.

According to another embodiment of the invention, the RSA modulus n is the product of three factors:
n=(Ap_{A}+1)×(Bp_{B}+1)×(Cp_{C}+1)
in which P_{A}, P_{B}, P_{C} are prime numbers greater in size than 320 bits,
(Ap_{A}+1), (Bp_{B}+1), (Cp_{C}+1) are RSA primes, denoted respectively p, q, r,
A, B and C are each the product of k/3 prime numbers (denoted p[i], i=1 to k), the p[i]s being of relatively small size (between 2 and 16 bits) and able to be mutually prime numbers and k being an integer number between 10 and 120, so that the product ABC has at least 160 bits.

This embodiment is of interest for speeding up the performance of the decryption. The decrypter, in order to speed up its calculations, performs the operations mod p mod q mod r. If n has 640 bits, splitting it into three factors makes the size of the factors smaller.

The present invention is intended to be disposed preferentially in items of encryption, decryption and key escrow equipment which are for example computers, chip cards, PCMCIA cards, badges, contactless cards or any other portable equipment.

The present invention also relates to a device comprising a cryptographic system, characterised in that it comprises an encryption system and/or a decryption system and/or a key escrow system, the said systems communicating with one another by an exchange of electronic signals or by means of an exchange of radio waves or infrared signals.

So as to better understand the invention, it is necessary to make the following comments.

The encryption method of the invention is broken down into three distinct phases:
generation of the keys
generation of the cryptogram
and decryption of the cryptogram.

Subsequently, the following (typographical) conventions will be used:
φ(n) will denote the Euler indicator function.
φ(n) is defined thus:
   if n=n₁×n₂×n₃× . . . ×nₖ₋₁×nₖ
   where n₁, n₂, n₃, . . . , nₖ₋₁, nₖ are prime numbers then:
   φ(n)=(n₁−1)×(n₂−1)×(n₃−1)× . . . ×(nₖ₋₁−1)×(nₖ−1)

First of all, and for a good understanding of the invention, it is necessary to describe the generation of the keys.

In order to generate the keys, the receiver of the cryptograms chooses at random two groups G_{A} and G_{B} of around k/2 small distinct primes p[i] (k being a system parameter of the order of 10 to 120) and forms the following two numbers (of approximately equal size):
A=the product of the p[i]s belonging to the set G_{A}
B=the product of the p[i]s belonging to the set G_{B}

For security reasons it seems appropriate to fix G_{A} and G_{B} such that:
1. G_{A}∩G_{B} is the null set
2. Certain p[i]s do not appear in G_{A}∪G_{B}.

The inventive method proves to be reliable (although with a somewhat more complex description) even if condition 2 is not satisfied. The method also remains reliable if condition 1 is not satisfied, but the key generation and decryption algorithms must be modified in consequence, and become notably more complex. Also, the p[i]s can be non-prime while being mutually prime (for example, integer powers of prime numbers of two or three bytes).

For the simplicity of the description, the i-th odd prime number will be denoted p[i], for example: p[1]=3, p[2]=5, p[3]=7, . . . .

It will be assumed subsequently that A is simply formed from the product of the p[i]s for i from 1 to k/2, and B from the product of the p[i]s for i from k/2+1 to k. However, this choice is not the best possible, and it must be interpreted only as a notational convention.

Next, the receiver of the cryptograms generates two large primes (typically of the order of 200 to 512 bits) denoted p_{A} and p_{B} such that p=Ap_{A}+1 and q=Bp_{B}+1 are RSA primes (RSA primes are such that, once multiplied, the product n=pq must be difficult to factorize).

In order to provide security, it appears preferable to impose minimum sizes on the different parameters:
1—the product AB must at minimum be a number of the order of 160 bits;
2—the size of each of the numbers p_{A}, p_{B} must exceed that of the product AB by at least 160 bits;
3—the size of the number n=p×q must be at least 640 bits.

The procedure for generating such primes does not fall within the scope of the present invention and proves to be self-evident for persons skilled in the art.

Finally, the receiver of the message generates and publishes an element g of order φ(n)/4.

It is imperative that such a g verifies the following condition:
For all i, there exists no x such that g=x^{p[i]} mod n.

g can be calculated with the help of one of the following methods:

*First Method of Calculating g (Fast):

The receiver of the message generates two integers:
gₚ, of order (p−1)/2 modulo p
g_{q}, of order (q−1)/2 modulo q

As above, the generation of gₚ is in practice equivalent to the creation of a number which is not a p[i]-th power for all i less than k/2; similarly for g_{q} with the obvious modifications:
set
   x₀=1
   t₁=1
   tᵢ=product of the p[j]s for j from 1 to i−1
2. for all i from 1 to k/2
   take a random x
   raise x to the power tᵢ
   if x_{(p-1)/p[i]}=1
      try another x
   otherwise
      calculate xᵢ=x(xᵢ₋₁)^{p[i]}
3. set gₚ=x_{k/2}
4. set
   x₀=1
   t₁=1
   tᵢ=product of the p[j]s for j from 1 to i−1
5. for all i from 1 to k/2
   take a random x
   raise x to the power tᵢ
   if x_{(q-1)/p[i]}=1
      try another x
   otherwise
      calculate xᵢ=x(xᵢ₋₁)^{p[i]}
6. set g_{q}=xₖ
7. construct g from gₚ and g_{q} by applying the Chinese remainder method (denoted CRT in the rest of the description), a method described in the work <<A course in number theory and cryptography>>, by Neal Koblitz, second edition, published by Springer-Verlag. It may be necessary to square the number produced in order to finally obtain g.

It is shown (the detail of such a proof is not necessary for understanding the present invention) that each step of the algorithm determines an element which is not a p[j]-th power for j less than or equal to i.

*Second Method of Calculating g (Simple)

An alternative approach consists of choosing g randomly and testing that such a g is not a p[j]-th power modulo n. A precise calculation shows that (on average) such a g will be found at the end of ln(k) random draws (that is, for k=120, around one chance in five).

So as to understand the invention well, it is now necessary to describe the generation of the cryptogram.

The cryptogram c of a message less than the product AB is calculated by the formula:
c=g^{m} mod n.

The description of the invention now turns towards a description of the decryption of the cryptogram.

In order to find m again, the decrypter performs the following operations:
1. calculate, for i from 1 to k: y[i]=c^{φ(n)/p[i]} mod n

Let m[i]=m mod p[i] and m′=(m−m[i])/p[i].

By substitution, it is easy to see that:

$$\begin{matrix}y [ i ] = {c}^{ϕ ( n ) / p [ i ]} mod n \\ = {g}^{m ϕ ( n ) / p [ i ]} mod n \\ = {g}^{( m [ i ] + {m}^{′} p [ i ] ) ϕ ( n ) / p [ i ]} mod n \\ = {g}^{m [ i ] ϕ ( n ) / p [ i ]} {g}^{{m}^{′} ϕ ( n )} mod n \\ = {g}^{m [ i ] ϕ ( n ) / p [ i ]} mod n\end{matrix}$$

2. for i from 1 to k do:
   for j from 1 to p[i] do:
   if g_{jφ(n)/p[i]} mod n=y[i] assign mᵢ=j
3. find
   m=CRT (m₁, m₂ . . . mₖ)

The decryption algorithm can be improved in various ways:

Typically, it is possible to pre-calculate and table the values g^{jφ(n)/p[i]} mod n for all values of the variables i and j necessary for the decryption to take place. In addition, such a table can be truncated or hashed provided that the method of truncation or hashing (denoted h) ensures that:
h[g^{jφ(n)/p[i]} mod n]≠h[g^{j′φ(n)/p[i]} mod n] if j≠j′

With such an embodiment, it proves possible to decrypt messages of 20 bytes with k=30 (the product AB then gives 160 bits, a modulus n of 80 bytes and a table of 4 kilobytes).

As mentioned in the <<key generation>> part, it may be more advantageous to choose 16 primes of 10 bits, instead of the 30 primes p[i] (k is then equal to 16). As there are 75 such primes, there are around 2^{52.9} possible choices. It is not necessary to publish the primes chosen, although this does not add any additional security.

It is even possible to choose mutually prime numbers; for example, powers of prime numbers, which further increases the range of choice of these parameters.

A second embodiment makes it possible to speed up the decryption by calculating, as soon as the cryptogram is received, the quantity:
z=c^{r} mod n, where r=p_{A}p_{B}

The quantities y[i] can then be calculated more easily by taking the following calculation short cut:
i[i]=z^{AB/p[i]} mod n
thus taking advantage of the difference in size between AB/p[i] and φ(n)/p[i] which speeds up the exponentiation.

A third embodiment makes it possible to speed up the decryption by separately decrypting the message modulo p and then modulo q (p and q being half the size of n, the decryption will be twice as fast) and composing the results modulo φ(n).

This alternative decryption method is described thus:
1. calculate, for i from 1 to k/2: y[i]=c^{φ(p)/p[i]} mod p

Let m[i]=m mod p[i] and m′=(m−m[i])/p[i].

By substitution, it is easy to see that:

$$\begin{matrix}y [ i ] = {c}^{ϕ ( n ) / p [ i ]} mod p \\ = {g}^{m ϕ ( p ) / p [ i ]} mod p \\ = {g}^{( m [ i ] + {m}^{′} p [ i ] ) ϕ ( p ) / p [ i ]} mod p \\ = {g}^{m [ i ] ϕ ( p ) / p [ i ]} {g}^{{m}^{′} ϕ ( p )} mod p \\ = {g}^{m [ i ] ϕ ( p ) / p [ i ]} mod p\end{matrix}$$

2. for i from 1 to k/2 do:
   for j from 1 to p[i] do:
   if g^{jφ(p)/p[i]} mod p=y[i] assign μ[i]=j
3. find:
   m mod φ(p)=CRT(μ[1] mod p[1], . . . μ[k/2] mod p[k/2])
4. perform steps {1, 2, 3} again with q in place of p.
5. calculate m=CRT(m mod φ(p), m mod φ(q))

It may prove necessary to protect the message m against manipulation by encrypting, by means of the method proposed in the present invention, f(key, m) in which f is a symmetric encryption function (for example the DES algorithm) of which the parameter <<key>> is accessible to all. Alternatively, the encryption method may verify that the message m obtained is correct such that its cipher is c. Another way of protecting m may be the encryption, by the method proposed, of m|hash(m), (that is to say c=g^{m|hash(m)} mod n) where hash(m) is a hashing of the message m, and | represents concatenation (in this case, the decryption verifies the integrity of the message obtained by calculating its hash).

It is possible to extend the encryption system described above to the case where the modulus n is no longer composed of two, but of three, factors. This will then give:
n=pqr
with p=Ap_{A}+1, q=Bp_{B}+1, r=Cp_{P}+1, P_{A}, P_{B}, P_{C} are three large primes (of 200 to 512 bits), and A, B, C are each the product of small distinct odd primes, coming from sets G_{A}, G_{B}, G_{C}.

The modifications to be made are self-evident to persons skilled in the art.

Furthermore, it appears possible to slightly relax condition 2 of the preceding descriptive part on the generation of keys (which is set out here: <<certain p(i)s do not appear in G_{A}∪G_{B}∪G_{C}>>). In this way, a set of parameters where n has 640 bits, the product ABC has 160 bits, and each of the p[i]s correlatively has 160 bits, provides appropriate security.

The second object of the present invention is to describe a key escrow system improving the method described by Y. Desmedt in <<Securing the traceability of ciphertexts—Towards a secure software key escrow system>> (Proceedings of Eurocrypt '95, Lecture Notes in Computer Science 921) and supplemented by the observations expressed by L. Knudsen and T. Pedersen in the article <<On the difficulty of software key escrow>> (Proceedings of Eurocrypt '96, Lecture Notes in Computer Science 1070).

In order to improve notably the key escrow function proposed by Y. Desmedt, a variant of the encryption method will be considered:

Let ID, the identity of each user, be coded in binary:
ID=Σ2ⁱ⁻¹ID[i]
where ID[i] are the bits of the identity of a user of the key escrow system (the sum being taken for i from 1 to k) and let e(ID)=Πp[i]^{ID[i]} (the product being taken for i from 1 to k).

Finally let c=g^{e(ID)u} mod n where u is a large random prime.

c is given to the user as the exponentiation base for El-Gamal encryption. The user derives, from c, his El-Gamal public key by choosing a random number x and raising c to the power x modulo n.

In order to trace the user, the said key escrow centre extracts, from the El-Gamal cryptogram of the user, the part:
v=c^{r} mod n
where r is the encryption random number chosen by the user.

Knowing φ(n), the said centre finds the bits ID[i] by means of the following algorithm:
1. calculate, for B+ur i from 1 to k: y[i]=
2. for i from 1 to k do:
   for j from 1 to p[i] do:
   if y[i]=1 assign μ[i] at 1, otherwise assign μ[i] at 0
3. calculate:
   ID′=Σ2ⁱ⁻¹μ[i]
4. find: ID=CCE(ID′)
   where CCE denotes an error correction mechanism (of the type of those described in the work (Correction Codes, Theory and Practice>> by A. Poli and L. Huguet, published by Masson) intended to correct the perturbations introduced in the case of an illicit use of a composite r.

The correction mechanism can be omitted; the algorithm making it possible to trace the user must then undergo modifications self-evident to persons skilled in the art, and use a number of quantities analogous to c^{r} mod n, corresponding to a number of executions of the El-Gamal encryption algorithm.

The third object of the present invention is to present a second key escrow system based on the so-called Diffie-Hellman key exchange mechanism, a mechanism patented under the reference U.S. Pat. No. 4,200,770.

In such a system, a number c, obtained by raising g to a random power a modulo n by one of the parties, is intercepted by the escrow authority.
c=g^{a} mod n

The said escrow authority finds a again in the following manner:
1. Knowing the factorization of n, the authority finds, with the help of the decryption algorithm, the value
   α=a mod AB
   that is a=α+βAB
2. The authority calculates:
   λ=c/g^{α} mod n=g^{βAB} mod n
   (since c=g^{a} mod n=g^{α+βAB mod} n=g^{α}g^{βAB} mod n)
3. Using a cryptanalysis algorithm (a discrete logarithm calculation algorithm, possibly executed twice (modulo p and modulo q) in order to speed up the performance thereof), the authority calculates the discrete logarithm β.
   λ=(g^{AB})^{β} mod n
4. The authority finds
   a=α+βAB
   and decrypts the communications based on the use of a.

The embodiment of the invention will be better understood from a reading of the description and the drawings which follow; in the accompanying drawings:

FIG. 1 depicts the flow diagram of an encryption system using the system proposed by the present invention,

FIG. 2 depicts the flow diagram of a decryption system using the system proposed by the present invention,

FIG. 3 depicts the data transmitted between the encryption system and the decryption system during the secure transmission of a message m.

According to the proposed invention, each item of encryption equipment (typically a computer or a chip card), is composed of a processing unit (CPU), a communication interface, a random access memory (RAM) and/or a non-writable memory (ROM) and/or a writable memory (generally re-writable) (a hard disk, diskette, EPROM or EEPROM).

The CPU and/or the ROM of the encryption equipment contain calculation resources or programs corresponding to the cryptogram generation rules (multiplication, squaring and modular reduction). Certain of these operations may be grouped together (for example, the modular reduction may be directly integrated into the multiplication).

Just as for the implementation of the RSA, the RAM typically contains the message m to which is applied the encryption and the calculation rules for generating the cryptogram. The disks and the E(E)PROM contain at least the parameters n and g generated and used as specified in the description which follows.

The CPU controls, via the address and data buses, the communication interface and the memory read and write operations.

Each item of decryption equipment (identical to the key escrow equipment) is necessarily protected from the outside world by physical or software protection. This protection should be sufficient to prevent any unauthorized entity from obtaining the secret key composed of secret factors of n. The techniques most used nowadays in this regard are integration of the chip in a security module and equipping of the chips with devices capable of detecting variations in temperature or light, as well as abnormal voltages and clock frequencies. Particular design techniques such as mixing up of the memory access are also used.

According to the proposed invention, the decryption equipment is composed at minimum of a processing unit (CPU) and memory resources (RAM, ROM, EEPROM or disks).

The CPU controls, via the address and data buses, the communication interface and the memory read and write operations. The RAM, EEPROM or disks contain the parameter φ(n) or, at least, the factors of φ(n).

The CPU and/or the ROM of the decryption equipment contain calculation resources or programs making it possible to implement the various steps of the decryption process described previously (multiplication, exponentiation and modular reduction). Certain of these operations may be grouped together (for example, the modular reduction may be directly integrated into the multiplication).

Within the general scope of the proposed invention, an encryption of the message m is implemented by exchanging, between the card, the signature equipment and the verification equipment, at least the data c.

1. A cryptographic system comprising at least one of an encryption system and a decryption system that utilizes public keys and a secret key, wherein said public keys comprise, at least:
a. an RSA modulus n, greater in size than 640 bits, having the following property:
n=(Ap_{A}+1)×(Bp_{B}+1)
in which:
p_{A} and p_{B} are prime numbers greater in size than 320 bits,
(Ap_{A}+1) is an RSA prime denoted p,
(Bp_{B}+1) is an RSA prime denoted q,
A is the product of k/2 (k being an even integer number between 10 and 120) prime numbers (denoted p[i], i=1 to k/2) of relatively small size (between 2 and 16 bits) and
B is the product of k/2 prime numbers (also denoted p[i], i=k/2+1 to k);
the p[i]s being of relatively small size (between 2 and 16 bits), and also able to be mutually prime;
b. an exponentiation base g, of order φ(n)/4 (where φ(n) denotes the Euler indicator function), g therefore having not to be a p[i]-th power modulo n of any number.

2. A cryptographic system according to claim 1 comprising at least an encryption/decryption system, wherein the encryption of a message m, m<AB, comprises the operation:
c=g^{m} mod n
where c denotes the cryptograph (encrypted message).

3. A cryptographic system according to claim 2 comprising an encryption/decryption system, wherein the integrity of a message m can be provided by the encryption of m|h(m) (h denoting a hashing function and | denoting concatenation), or by the encryption of DES (key, m), where said key is a key accessible to all.

4. A cryptographic system according to claim 1 comprising an encryption/decryption system, and a key escrow system, wherein the secret key of a decrypter or of an escrow authority is the number φ(n), and wherein the operation of decryption or of recovering the identity of a user comprises the following steps:
a. calculating, for i from 1 to k: y[i]=c^{φ(n)/p[i]} mod n;
b. for i from 1 to k
for j from 1 to p[i]
comparing y[i] with the values g^{jφ(n)/p[i]} mod n independent of m;
if g^{jφ(n)/p[i]} mod n=y[i] then assign μ[i]=j
c. reconstructing a message m from the Chinese remainder theorem CRT and the values μ[i].

5. A cryptographic system according to claim 4 comprising an encryption/decryption system and a key escrow system, wherein said decrypter speeds up the calculation of the quantities y[i] by calculating:
a) z=c^{r} mod n where r=p_{A}p_{B}
b) for i from 1 to k: y[i]=z^{AB/p[i]} mod n,
so as to take advantage of the difference in size between AB/p[i] and φ(n)/p[i] for speeding up the calculations.

6. A cryptographic system according to claim 4 comprising an encryption/decryption system and a key escrow system, wherein the decrypter pre-calculates and saves, once and for all, the table of values g^{jφ(n)/p[i]} mod n for 1≦i≦k and 1≦j≦p[i] or, a truncation or a hashing of these values (denoted h) having the following property:
h(g^{jφ(n)/p[i]} mod n)≠h(g^{j′φ(n)/p[i]} mod n) if j≠j′.

7. A cryptographic system according to any one of claims 4 to 6 comprising an encryption/decryption system and a key escrow system, wherein the decrypter speeds up its calculations by separately decrypting the message modulo p and then modulo q, and constructing the modulo results with the help of the Chinese remainder theorem in order to find m again.

8. A cryptographic system according to claim 4, wherein a key escrow authority implements the following steps:
a. it codes the identify of the user ID=Σ2ⁱ⁻¹ID[i] where ID[i] are the bits of the identity of the said user of the system (the sum being taken for I from 1 to k) by calculating e(ID)=πp[i]^{ID(i)} (the product being taken for 1 from 1 to k);
b. it issues, to the user, an El-Gamal key (that is to say an exponentiation base) c=g^{e(ID)u} mod n, in which u is a large random prime or a number prime with φ(n);
c. it thus makes it possible for the user to derive, from c, his El-Gamal public key by choosing a random number x and raising c to the power x modulo n;
d. with the aim of finding the trace of the user, the authority extracts, from an El-Gamal cryptogram of an encrypter, said cryptogram always comprising two parts, the part:
v=c^{r} mod n
where r is the encryption random number chosen by the encrypter;
e. knowing φ(n), said authority finds the bits ID[i] by means of the following algorithm:
1. calculate, for i from 1 to k: y[i]=v^{φ(n)/p[i]} mod n
2. if y[i]=1, then μ[i]=1, otherwise μ[i]=0
3. calculate:
ID′=Σ2ⁱ⁻¹μ[i]
4. find: ID=CCE(ID′)
in which CCE denotes an error correction mechanism.

9. A cryptographic system according to claim 4 comprising a key escrow system, based on a Diffie-Hellman key exchange mechanism where a number c, obtained by raising g to a random power a modulo n by one party, is intercepted by said escrow authority:
c=g^{a} mod n
said escrow authority finds a again in the following manner:
a. knowing the factorization of n, said authority finds, with the help of the decryption algorithm, the value
α=a mod AB
that is a=α+βAB;
b. said authority calculates: λ=c/g^{α} mod n=g^{βAB} mod n
c. using a cryptanalysis algorithm, the authority calculates the discrete logarithm β
λ=(g^{AB})^{β} mod n
d. the authority finds
a=α+βAB
and decrypts the communications based on the use of a.

10. A cryptographic system according to claim 2 comprising an encryption/decryption system and a key escrow system, wherein the RSA modulus n is the product of three factors:
n=(Ap_{A}+1)×(Bp_{B}+1)×(Cp_{c}+1)
in which p_{A}, p_{B}, p_{C} are prime numbers greater in size than 320 bits,
(Ap_{A}+1), (Bp_{B}+1), (Cp_{c}+1) are RSA primes, denoted respectively p, q, r,
A, B and C are each the product of k/3 prime numbers (denoted p[i], i=1 to k), the p[i]s being of relatively small size (between 2 and 16 bits) and able to be mutually prime numbers and k being an integer number between 10 and 120, so that the product ABC has at least 160 bits.

11-12. (canceled)

13. A cryptographic system including at least one of an encryption system and a decryption system that uses a public key and a private key in providing secure encryption and decryption of a message m, the public key comprising:
an RSA modulus n, wherein n is greater than 640 bits, and wherein n=(Ap_{A}+1)(Bp_{B}+1), wherein p_{A} and p_{B} are prime numbers greater in size than 320 bits, (Ap_{A}+1) is an RSA prime denoted p, (Bp_{B}+1) is an RSA prime denoted q, A is the product of k/2 prime numbers p[i], i=1 to k/2, B is the product of k/2 prime numbers p[i], i=1 to k/2, the p[i]'s being mutually prime, and wherein k is an even integer; and
an exponentiation base g, wherein g is of the order φ(n)/4, φ(n) being the Euler indicator function.

14. The cryptographic system of claim 13, wherein the message m is encrypted into a cryptogram c according to c=g^{m} mod n.

15. The cryptographic system of claim 14, wherein the integrity of the message m can be provided by the encryption m|h(m) wherein h(m) is a hashing function and | denotes concatenation.

16. The cryptographic system of claim 14, wherein the integrity of the message m can be provided by the encryption of a DES key, wherein the DES key is publicly available.

17. The cryptographic system of claim 13, wherein the secret key is equal to φ(n), and wherein decryption of the message m according to reconstructing the message m from the Chinese remainder theorem CRT and the values μ[i], where μ[i]=j when g^{jφ(n)/p[i]} mod n=y[i], y[i]=c^{φ(n)/p[i]} mod n.

18. The cryptographic system of claim 17, wherein the decrypter speeds up its calculations by separately decrypting the message modulo p and then modulo q, and constructing the modulo results with the help of the Chinese remainder theorem to obtain the message m.

19. The cryptographic system of claim 17, further comprising:
an El-Gamal key c=g^{e(ID)u} mod n, wherein u is a large random prime, ID=Σ2¹⁻¹ID[i], ID[i] representing bits of the identity of a user of the system.

20. A method of encrypting a message m, comprising:
calculating n according to n=(Ap_{A}+1)(Bp_{B}+1), wherein p_{A} and p_{B} are prime numbers greater in size than 320 bits, (Ap_{A}+1) is an RSA prime denoted p, (Bp_{B}+1) is an RSA prime denoted q, A is the product of k/2 prime numbers p[i], i=1 to k/2, B is the product of k/2 prime numbers p[i], i=1 to k/2, the p[i]'s being mutually prime, and wherein k is an even integer; and
calculating a cryptogram of the message m according to c=g^{m} mod n, wherein the exponentiation base g is of the order φ(n)/4, φ(n) being the Euler indicator function.

21. The method of claim 20, wherein the message m is decrypted, further comprising:
calculating for i=1 to k: y[i]=c^{φ(n)/p[i]} mod n;
comparing y[i] with values g^{jφ(n)/p[i]} mod n independent of m, for I from 1 to k and j from 1 to p[i];
if g^{jφ(n)/p[i]} mod n=y[i] then assign μ[i]=j; and
reconstructing the message m from the Chinese remainder theorem CRT and the values μ[i].

22. The method of claim 21, wherein the decrypter speeds up the calculation of the quantities y[i]=z^{AB/p[i]} by calculating z=c^{r} mod n where r=p_{A}p_{B} for =1 to k.

23. The method of claim 21, wherein the decrypter calculates and saves the table of values g^{jφ(n)/p[i]} mod n for i from 1 to k and j for 1 to p[i].
